(19) United States
(12) Patent Application Publication
(10) Pub. No.: US 2017/0160854 A1
(43) Pub. Date: Jun. 8, 2017

(54) TOUCH AND PRESSURE SENSITIVE PANEL

(71) Applicant: Ming-Jhih Huang, Taipei (TW)

(72) Inventor: Ming-Jhih Huang, Taipei (TW)

(73) Assignee: Luminous Optical Technology Co., Ltd., Taipei (TW)

(21) Appl. No.: 14/956,397

(22) Filed: Dec. 2, 2015

(51) Int. Cl. G06F 3/041

(52) U.S. Cl. CPC G06F 3/0414; G06F 2203/04102

(57) ABSTRACT

The panel is composed of a touch sensing structure and a touch pressure sensing structure, which separately include functional layers. The touch sensing structure can determine the location of a touch by a change in capacitance on the surface when touching the panel. The touch pressure sensing structure has a strain isolation layer with a property of elastic deformation between electrodes for detecting pressure applied onto the panel by a change in capacitance resulting from relative displacement between two electrodes.

### BACKGROUND OF THE INVENTION

1. Technical Field

The invention relates to input devices for portable computers, particularly to touchscreens.

2. Related Art

For inputting texts, touchscreen modules have been extensively applied in smartphones, tablets and laptop computers. Conventional touchscreens can detect a coordinate of the position which is being touched, so they can cooperate with the screen picture to input texts or make an operation. In some cases, such an operating mode may meet a difficulty, for example, a virtual key shown on a touchscreen may be unexpectedly activated because it merely needs a very light force or even does not need a force to apply thereon. In order to avoid such a problem, how to correctly detect a touching operation to a virtual key is the core. A currently known solution is to add a pressure sensor under the touchscreen, by which a force exerted on the touchscreen can be detected. As a result, a touching operation can be correctly determined.

U.S. Pat. No. 8,988,384 discloses a force sensor interface in a touch controller of a touch sensitive device, which includes one or more touch sensors and one or more force sensors. The touch controller can correctly determine a touch operation by associating a touch signal with a force signal. The touch sensitive device includes a rigid cover, under which the touch sensors and force sensors are arranged. The rigid cover will not be bent or deformed to trigger the force sensor. Such a force sensor is a strain gauge based upon a resistor bridge a shown in FIG. 4B. The strain gauge is a force sensitive variable resistor which varies in resistance depending on a force applied thereon. As a result, the force sensor can detect the force from a touching operation. In this solution, the touch sensors and the force sensors are independent elements and the force sensors are disposed near or under the touch sensors. It is a serious challenge in assembling accuracy. And the force sensors will also increase an overall thickness of a touch sensitive device. This is not advantageous to portable devices. Additionally, the rigid cover must be movable to deliver the applied force to the force sensors, so such a movable mechanism may reduce or damage a sealing effect of the product.

### SUMMARY OF THE INVENTION

An object of the invention is to provide a touch and pressure sensitive panel, which is easy to be manufactured. Thus its manufacturing cost can be effectively reduced.

Another object of the invention is to provide a touch and pressure sensitive panel, which is a flexible thin plate without any movable mechanism. Thus it will not reduce or damage a sealing effect of a product using it.

To accomplish the above objects, the touch and pressure sensitive panel of the invention includes:

a surface layer, being a flexible transparent sheet;

an insulative layer, being a flexible transparent sheet;

a first electrode layer, being a flexible transparent conductive film, sandwiched between the surface layer and the insulative layer, and having sensing electrodes covered by the surface layer;

a second electrode layer, being a flexible transparent conductive film, disposed under the insulative layer, and having driving electrodes, wherein the insulative layer is sandwiched between the first electrode layer and the second electrode layer to form a touch sensing structure;

a strain isolation layer, disposed under the second electrode layer, and having a property of elastic deformation

a third electrode layer, disposed under the strain isolation layer, and having sensing electrodes; and

a base layer, being a rigid transparent sheet, disposed under the third electrode layer;

wherein the sensing electrodes on the third electrode layer and the driving electrodes on the second electrode layer face each other and keep a gap therebetween, the strain isolation layer completely fill the gap, and the second and third electrode layers and the strain isolation layer constitute a touch pressure sensing structure.

### BRIEF DESCRIPTION OF THE INVENTION

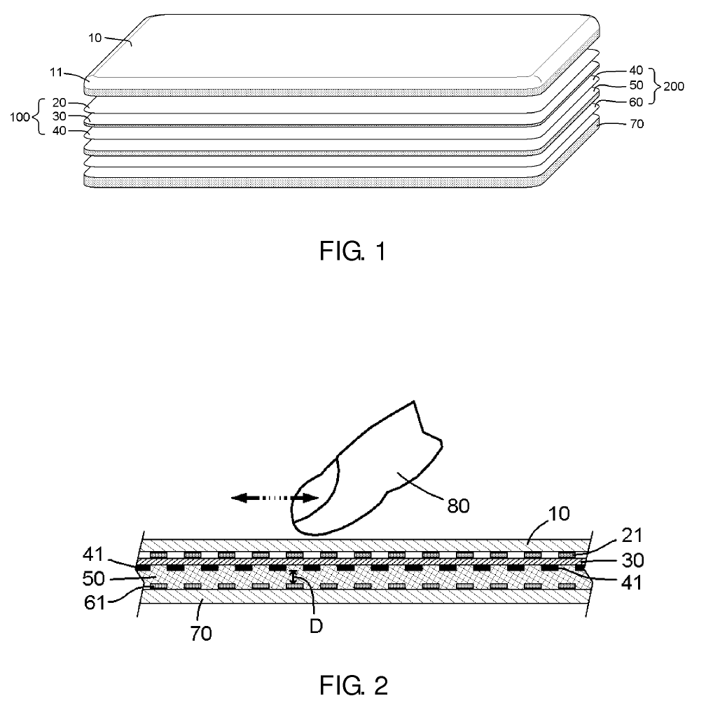

FIG. 1 is an exploded view of the invention;

FIG. 2 is a cross-sectional view of the invention;

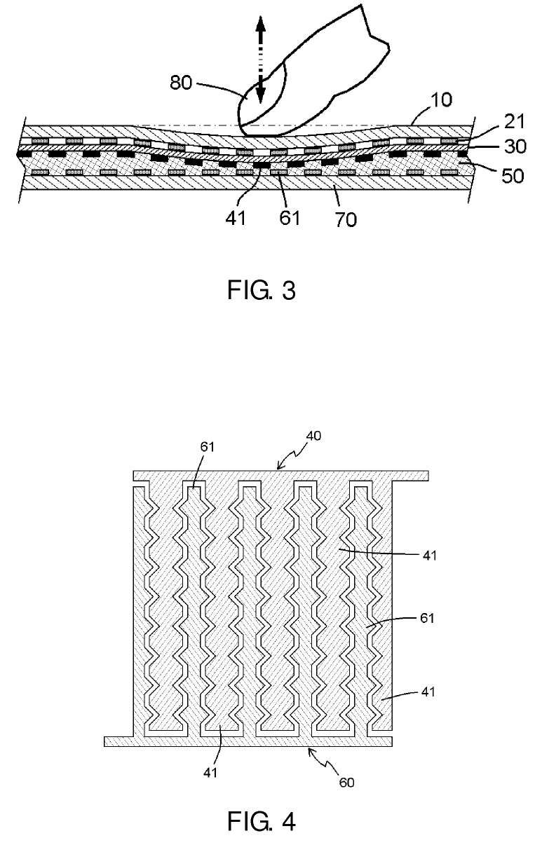

FIG. 3 is another cross-sectional view of the invention when being pressed;

FIG. 4 is a schematic view of patterns of the second and third electrode layers; and

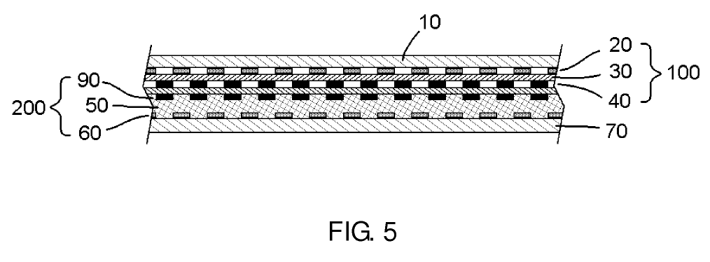

FIG. 5 is a cross-sectional view of another embodiment of the invention.

### DETAILED DESCRIPTION OF THE INVENTION

Please refer to FIGS. 1 and 2. As shown, the touch and pressure sensitive panel of the invention includes a surface layer 10, a first electrode layer 20, an insulative layer 30, a second electrode layer 40, a strain isolation layer 50, a third electrode layer 60 and a base layer 70.

The surface layer 10 is made of a transparent sheet material, such as an optical glass sheet. To make the surface layer 10 flexible, its thickness is about 0.4 mm. Also, the surface layer 10 may be further reinforced by a chemical or tempering process. Additionally, each of four corners of the surface layer 10 is formed with a chamfering 11 to prevent the surface layer 10 from peeling off.

The first electrode layer 20 is a flexible transparent conductive film, such as an ITO (indium tin oxide) conductive film, and is sandwiched between the surface layer 10 and the insulative layer 30. There are sensing electrodes 21 at regular intervals on the first electrode layer 20.

The insulative layer 30 is a flexible transparent sheet, for example, an optical glass plate or PMMA (polymethylmethacrylate) or COP (cyclo olefin polymers) thin plate with a thickness of about 0.1 mm. Alternately, the insulative layer 30 may select a dielectric material to improve a gain of touch signal.

The second electrode layer 40 is a flexible transparent conductive film, such as an ITO conductive film, and is disposed under the insulative layer 30. There are driving electrodes 41 at regular intervals on the second electrode layer 40. Preferably, an ITO conductive layer may be directly formed on each side of the insulative layer 30 in advance, and then an etching process is applied to form an electrode pattern.

The base layer 70 is a rigid transparent plate, such as an optical glass sheet with a thickness of about 0.2 mm. The rigid base layer 70 can provide support to the third electrode layer 60 to prevent from being bent by pressure. Usually, the invention is used for being disposed over a display (not shown), so the base layer 70 can be supported by the display on which the invention is placed. As a result, the base layer 70 will not be bent by normal pressure.

The third electrode layer 60 is a transparent conductive film, such as an ITO conductive film. There are sensing electrodes 61 at regular intervals on the third electrode layer 60. The third electrode layer 60 is disposed on the base layer 70 and under the second electrode layer 40 with a parallel gap D, which is about 150 μm.

The strain isolation layer 50 is formed by filling the space formed by the gap D with a transparent insulative material with a property of elastic deformation. The strain isolation layer 50 isolates the second and third electrode layers 40, 60. The strain isolation layer 50 will be deformed by pressure applied on the surface layer 10, its property of elastic deformation allows the electrodes 41, 61 to change their relative positions, for example, shortening a vertical distance between two opposite electrodes or changing a horizontal interval between two adjacent electrodes. When the pressure removes, the strain isolation layer 50 resumes to its original shape and restores relative positions between two opposite layers of electrodes 41, 61. The strain isolation layer 50 may select a material with a low index of refraction or an index of refraction near that of glass, such as an OCA (optical clear adhesive) or a dielectric material. When an OCA is adopted, it can further provide adhesion between the second and third electrode layers 40, 60. When a dielectric material is used, it can gain a touch signal of a touching operation.

The first electrode layer 20, the second electrode layer 40 and the insulative layer 30 constitute a touch sensing structure 100. Of course, the sensing electrodes 21 on the first electrode layer 20 and the driving electrodes 41 on the second electrode layer 40 can be separately electrically connected to a touch controller (not shown).

As shown in FIG. 2, when a touching matter 80 such as a finger nears the surface layer 10, the driving electrodes 41 near the touching matter 80 capacitively couple the touching matter 80, and then charges will be grounded from the stimulated driving electrodes 41 through the touching matter 80. This can reduce capacitance between the driving electrodes 41 and the sensing electrodes 21. This change of capacitance can be interpreted as a touching position.

The second electrode layer 40, the third electrode layer 60 and the strain isolation layer 50 constitute a touch pressure sensing structure 200. Of course, the driving electrodes 41 on the second electrode layer 40 and the sensing electrodes 61 on the third electrode layer 60 can be separately electrically connected to a touch controller (not shown).

Please refer to FIG. 3. When a touching matter 80 applies pressure on the surface layer 10, the surface layer 10, the first electrode layer 20, the insulative layer 30 and the second electrode layer 40 will be bent, and the strain isolation layer 50 generates elastic deformation to make the distances between the driving electrodes 41 on the second electrode layer 40 and the sensing electrodes 61 on the third electrode layer 60 shortened. As a result, capacitance between the two opposite electrodes 41, 61 will increase proportionally to the measurement of the pressure and the gap capacitance will also increase correspondingly. Besides, the elastic deformation of the strain isolation layer 50 also makes horizontally relative positions between the driving electrodes 41 and the sensing electrodes 61 shifted and a part of these electrodes 41, 61 will overlap with each other. This also causes increase of capacitance between two electrodes and the capacitance increases proportionally to the measurement of the pressure, i.e., overlapping capacitance increases correspondingly. As a result, this change of capacitance can be interpreted as pressure applied on the surface layer 10.

In order to increase sensible capacitance between the second and third electrode layers 40, 60, the driving electrodes 41 and the sensing electrodes 61 can be formed into a grid shape with an interlacing arrangement as shown in FIG. 4. This can enhance accuracy of detection of pressure from the touching matter 80. As a result, the touch pressure sensing structure 200 can obtain various levels of pressure measurement.

In the above embodiment, the touch sensing structure 100 is the same as the touch pressure sensing structure 200 in fundamental framework. Accordingly, the invention can be applied without changing currently existing capacitive touchscreens, even can be compatible to currently existing controllers for capacitive touchscreens. This can effectively save costs of development of a new component. Furthermore, the touch sensing structure 100 and the touch pressure sensing structure 200 commonly share the driving electrodes 41 on the second electrode layer 40. However, in another embodiment, a fourth electrode layer 90 can be further added between the second electrode layer 40 and the strain isolation layer 50 as shown in FIG. 5. The fourth electrode layer 90 is a flexible transparent conductive film and has driving electrodes 91. The fourth electrode layer 90, the third electrode layer 60 and the strain isolation layer 50 constitute a touch pressure sensing structure 200. This creates an arrangement that each sensing electrode 61 associates with an exclusive driving electrode 91 to further improve sensing accuracy.

It will be appreciated by persons skilled in the art that the above embodiments have been described by way of example only and not in any limitative sense, and that various alterations and modifications are possible without departure from the scope of the invention as defined by the appended claims.

What is claimed is:

1. A touch and pressure sensitive panel comprising:
a surface layer, being a flexible transparent sheet;
an insulative layer, being a flexible transparent sheet;
a first electrode layer, being a flexible transparent conductive film, sandwiched between the surface layer and the insulative layer, and having sensing electrodes covered by the surface layer;
a second electrode layer, being a flexible transparent conductive film, disposed under the insulative layer, and having driving electrodes, wherein the insulative layer is sandwiched between the first electrode layer and the second electrode layer to form a touch sensing structure;
a strain isolation layer, disposed under the second electrode layer, and having a property of elastic deformation
a third electrode layer, disposed under the strain isolation layer, and having sensing electrodes; and
a base layer, being a rigid transparent sheet, disposed under the third electrode layer;
wherein the sensing electrodes on the third electrode layer and the driving electrodes on the second electrode layer face each other and keep a gap therebetween, the strain isolation layer completely fill the gap, and the second and third electrode layers and the strain isolation layer constitute a touch pressure sensing structure.

2. The touch and pressure sensitive panel of claim 1, wherein the sensing electrodes of the first and third electrode layers have identical or similar patterns.

3. The touch and pressure sensitive panel of claim 1, wherein the gap is about 75˜200 μm.

4. The touch and pressure sensitive panel of claim 1, wherein the strain isolation layer is formed by an OCA (optical clear adhesive).

5. The touch and pressure sensitive panel of claim 1, wherein the strain isolation layer is formed by a dielectric material.

6. The touch and pressure sensitive panel of claim 5, wherein the dielectric material is polyethylene, phenolic resin or inorganic glass.

7. The touch and pressure sensitive panel of claim 1, wherein the driving electrodes of the second electrode layer and the sensing electrodes of the third electrode layer are formed in a grid shape with an interlacing arrangement.

8. The touch and pressure sensitive panel of claim 1, further comprising a fourth electrode layer added between the second electrode layer and the strain isolation layer, wherein the fourth electrode layer is a flexible transparent conductive film and has driving electrodes, and the fourth electrode layer, the third electrode layer and the strain isolation layer constitute a touch pressure sensing structure.

9. The touch and pressure sensitive panel of claim 1, wherein the surface layer is made of a reinforced optical glass with a thickness of about 0.2˜0.3 mm.

10. The touch and pressure sensitive panel of claim 1, wherein each of four corners of the surface layer is formed with a chamfering.
